(19) United States
(12) Patent Application Publication
(10) Pub. No.: US 2026/0208347 A1
(43) Pub. Date: Jul. 23, 2026

(54) METHOD AND APPARATUS FOR COOPERATIVE CONTROL OF LIBRARY SYSTEM

(71) Applicant: KOREA INSTITUTE OF SCIENCE AND TECHNOLOGY, Seoul (KR)

(72) Inventors: Sona KWAK, Seoul (KR); Jongsuk CHOI, Seoul (KR); Yoonseob LIM, Seoul (KR); Jun-Sik KIM, Seoul (KR); Kanggeon KIM, Seoul (KR); Soonkyum KIM, Seoul (KR); Dahyun KANG, Seoul (KR); Dohyeon KIM, Seoul (KR); Eunbin JEONG, Seoul (KR); Esranur ERTURK, Seoul (KR); Chang Reung PARK, Seoul (KR)

(73) Assignee: KOREA INSTITUTE OF SCIENCE AND TECHNOLOGY, Seoul (KR)

(21) Appl. No.: 19/455,035

(22) Filed: Jan. 21, 2026

(30) Foreign Application Priority Data
Jan. 21, 2025 (KR) 10-2025-0008840

(51) Int. Cl. B25J 9/00; B25J 11/00; G06F 16/2457; G06T 7/246; G06T 7/50; G06V 10/25; G06V 40/10

(52) U.S. Cl. CPC B25J 9/0003; B25J 11/008; G06F 16/24575; G06T 7/246; G06T 7/50; G06V 10/25; G06V 40/10; G06T 2207/10028; G06T 2207/30196; G06T 2207/30244

(57) ABSTRACT

The present disclosure relates to a technology for controlling a robotic product and provides a method for collaborative control of a library system including a bookshelf robot and a stool robot, including estimating, by the library system, a user's height using at least one sensor and detecting whether the user is approaching the bookshelf robot or the stool robot to obtain situational information about objects within a library space, recognizing, by the library system, the user's intention or situational context based on the acquired information and a book request input by the user, and selecting, by the library system, a task corresponding to the recognized user's intention or situational context and instructing each of the bookshelf robot and the stool robot, which collaboratively perform the selected task, to provide services.

### CROSS REFERENCE TO RELATED APPLICATION

The present application claims priority to Korean Patent Application No. 10-2025-0008840, filed Jan. 21, 2025, the entire contents of which is incorporated herein for all purposes by this reference.

### BACKGROUND

### Field of the Invention

The present disclosure relates to a technology for controlling a robotic product, and more specifically, to a method and apparatus for controlling a bookshelf robot and a stool robot that cooperate to provide necessary services to library users.

### Description of Related Art

Robots with various functions are being developed to replace human tasks or provide useful services to humans. However, conventional technologies primarily focus on allowing a single robot to independently perform a given task, limiting their ability to perform tasks in diverse situations or for diverse purposes, which are currently required. For example, since human-robot interaction based on a single robotic product involves only one type and one unit of robot, the user information and environmental information that the robot can obtain are limited.

To address this issue, research is being conducted on robot control methods for collaboration between humans and robots or between a plurality of robots. The human-robot collaboration model is a model in which human work intelligence is combined with the control functions of a robot and is a technology that involves human intervention in work due to the limitations of robot intelligence. In addition, collaboration between a plurality of robots is a technology that enables robots to autonomously exchange information about their surroundings and perform tasks. The patent document presented below presents a multi-robot system and a method of controlling a multi-robot system, which considers the task suitability of robots to optimally allocate specific tasks to a plurality of robots.

Despite the growing importance of multi-robot systems, which efficiently perform given tasks through collaborative task planning and execution among a plurality of robots, conventional human-robot interaction based on a plurality of robotic products mainly employes homogeneous robots, thereby limiting the range of tasks that the robots can perform and restricting them to providing only their inherent product functions. That is, since robots provide only a single service to users, the robots are unable to provide a rich user experience.

Meanwhile, libraries are adopting robotic automation services to enhance user convenience and operational efficiency with technological advancements. These services automate various tasks, such as book checkout and return, shelf organization, and information services, reducing the workload of library staff and enhancing user experience. In particular, robotics can accurately locate books on shelves or place returned books at designated locations through precise location tracking and movement capabilities. In addition, autonomous driving technology and artificial intelligence (AI) can be combined to deliver books upon user request, or provide interactive services such as route guidance and facility information within the library.

However, conventional robotic automation systems are often designed and operated individually, resulting in insufficient integration and collaborative control with other library systems (e.g., not for circulation, loan management, inventory management, etc.).

Accordingly, there is a need for a new automated control technology designed to enable organic collaboration and real-time integrated operation among various systems and robots within a library. In addition, in an environment in which a plurality of heterogeneous robotic products coexist, there is a need for a technological unit that enables library users to independently identify appropriate tasks and enable various robotic products within the library to collaborate to provide personalized services.

### RELATED ART DOCUMENT

### Patent Document

Korean Patent Registration No. 10-1408075, “multi-robot system and method of controlling multi-robot system”

### SUMMARY OF THE INVENTION

Various embodiments of the present disclosure are directed to resolving the weakness of conventional multi-robot systems introduced to libraries, which was developed mainly with a focus on task allocation of homogeneous robots, resulting in very little interaction between heterogeneous robotic products, overcoming the limitation that services that can be provided by multi-robots are limited to unique functions of the robots, and resolving a problem that user experience in libraries is insufficient or deficient due to the limited provision of services.

According to one embodiment of the present disclosure, there is provided a method for collaborative control of a library system including a bookshelf robot and a stool robot, including estimating, by the library system, a user's height using at least one sensor and detecting whether the user is approaching the bookshelf robot or the stool robot to obtain situational information about objects within a library space, recognizing, by the library system, the user's intention or situational context based on the acquired information and a book request input by the user, and selecting, by the library system, a task corresponding to the recognized user's intention or situational context and instructing each of the bookshelf robot and the stool robot, which collaboratively perform the selected task, to provide services.

The method may further include registering at least one unit function provided by each of the bookshelf robot and the stool robot and generating in advance performable tasks for collaborative operation by a plurality of robots from a combination of the registered unit functions.

The unit function may a unique function corresponding to an action performable by one bookshelf robot or stool robot and any one of a plurality of functions applicable as different roles depending on the user's intention and situational context with respect to the performable action of the one bookshelf robot or stool robot, and the task may consist of a plurality of unit functions that process complex actions necessary to achieve objectives, each unit function is matched with the bookshelf robot or stool robot that provides the corresponding unit function, and a sequence of actions and communication targets among a plurality of robots cooperating to achieve the objectives is configured.

The recognizing of the user's intention or the situational context may include receiving additional information about a book request from the user, and selecting an item that is most similar among candidates for the user's intention or situational context based on the input additional information and the detected information.

The instructing of each of the bookshelf robot and the stool robot to provide a service may include selecting a task corresponding to the recognized user's intention or situational context, identifying a plurality of unit functions matching the selected task, and instructing each of the bookshelf robot and the stool robot that perform the identified unit functions to perform the corresponding unit functions in a time-series manner.

The instructing of each of the bookshelf robot and the stool robot to perform the corresponding unit functions in a time-series manner may include activating a drawer opening function by instructing the bookshelf robot to protrude a requested book or a drawer storing the requested book, and deactivating the drawer opening function of the bookshelf robot by detecting the user's book retrieval using the at least one sensor.

The instructing of each of the bookshelf robot and the stool robot to perform the corresponding unit functions in a time-series manner may further include recognizing the protruded requested book or drawer corresponding to the activated drawer opening function using the at least one sensor, setting the recognized book or drawer as a region of interest (ROI), estimating movement of a book within the set ROI using an optical flow algorithm, and determining whether the estimated movement of the book crosses a threshold line set adjacent to the ROI, and the deactivating of the drawer opening function includes, when the movement of the book crosses the threshold line, determining that the user has received the book and returning the protruded drawer to its original location.

The instructing of each of the bookshelf robot and the stool robot to perform the corresponding unit functions in a time-series manner may include selectively moving the stool robot to activate a ladder function for supporting the user based on a difference between the estimated height of the user and a book storage location of the bookshelf robot the user is approaching, or selectively moving the stool robot and activating a support platform function for carrying books, based on an quantity of books detected using the at least one sensor.

The activating of the ladder function for supporting the user may include acquiring coordinate values of a camera coordinate system for a head joint of the user based on depth information measured using the at least one sensor, calculating a Euclidean distance, with respect to a floor plane of a space in which the user is located, from the coordinate values in the camera coordinate system using a transformation between the camera coordinate system and a world coordinate system, and estimating the user's height by adding an offset corresponding to a head region to the calculated Euclidean distance.

Furthermore, hereinafter, there is provided a computer-readable recording medium in which a program for executing the method for cooperative control of a library system in a computer is recorded.

According to one embodiment of the present disclosure, there is provided a library system for cooperatively controlling a bookshelf robot and a stool robot, including a communication unit configured to receive measurement values detected using at least one sensor, and a processor configured to execute commands to control the bookshelf robot and the stool robot to provide a service required by a user, wherein the processor is configured to estimate a user's height based on the input measurement values, detect whether the user approaches the bookshelf robot or the stool robot to acquire situational information about objects in a library space, recognize the user's intention or situational context based on the acquired information and a book request input by the user, select a task corresponding to the recognized intention or situational context, and instruct each of the bookshelf robot and the stool robot that cooperatively perform the selected task to provide a service.

The processor may be configured to register at least one unit function provided by each of the bookshelf robot and the stool robot and generate in advance performable tasks for collaborative operation by a plurality of robots from a combination of the registered unit functions.

The processor may be configured to receive additional information about the book request from the user and recognize the user's intention or situational context by selecting an item that is most similar among candidates for the user's intention or situational context based on the input additional information and detected information.

The processor may be configured to select a task corresponding to the recognized user's intention or situational context, identify a plurality of unit functions matched to the selected task, and instruct each of the bookshelf robot and the stool robot that perform the identified unit functions to perform a corresponding unit function in a time-series manner.

The processor may be configured to activate a drawer opening function by instructing the bookshelf robot to protrude a requested book or a drawer storing the requested book, recognize the protruded requested book or drawer corresponding to the activated drawer opening function using the at least one sensor, set the recognized book or drawer as a region of interest (ROI), estimate movement of a book within the set ROI using an optical flow algorithm, and determine whether the estimated movement of the book crosses a threshold line set adjacent to the ROI, and when the movement of the book crosses the threshold line, determine that the user has retrieved the book and return the protruded drawer to its original position to deactivate the drawer opening function.

The processor may be configured to acquire coordinate values of a head joint of the user in a camera coordinate system based on depth information measured by the at least one sensor, calculate a Euclidean distance from the coordinate values in the camera coordinate system to a floor plane of a space in which the user is located using conversion between the camera coordinate system and a world coordinate system, estimate the user's height by adding an offset corresponding to a head region to the calculated Euclidean distance, and activate a ladder function by selectively moving the stool robot based on a difference between the estimated height of the user and a book storage position of the bookshelf robot approached by the user, or selectively move the stool robot and activate a support platform function for carrying books, based on an quantity of books detected using the at least one sensor.

According to various embodiments of the present disclosure, by sharing user information and environmental information acquired from a plurality of homogeneous and heterogeneous robotic products and sensors installed in a library through communication between robots, the intentions of library users can be more specifically identified and the situational context can be recognized more efficiently, and by integrating the functions of each robot through collaboration between the robots, optimal user services for library users and a rich user experience beyond the unique functions of the robots can be provided.

### BRIEF DESCRIPTION OF THE DRAWINGS

FIG. 1 is a view illustrating a library space and situation in which various embodiments of the present disclosure are implemented to adaptively establish optimal service strategies for network-connected robotic products.

FIG. 2 is a view for describing a device configuration of the robotic products illustrated in FIG. 1.

FIG. 3 is a flowchart illustrating a method of collaboratively controlling a library system including a bookshelf robot and a stool robot according to one embodiment of the present disclosure.

FIG. 4 is a view illustrating a configuration of tasks proposed by various embodiments of the present disclosure.

FIG. 5 is a view for describing a configuration of intention or context candidates proposed by various embodiments of the present disclosure.

FIG. 6 is a view for describing a process of selecting a task based on the intention or context of FIG. 5.

FIG. 7 is a view for describing a connection structure among devices in the library system for implementing various embodiments of the present disclosure.

FIG. 8 is a block diagram illustrating the library system for collaboratively controlling a bookshelf robot and a stool robot according to one embodiment of the present disclosure.

FIGS. 9 to 11 are views for describing the operation of a drawer opening function using a prototype of a bookshelf robot for the library system.

FIG. 12 is a view for describing a process of estimating a user's height using a sensor prototype for the library system.

FIG. 13 is a view illustrating a prototype of a stool robot for the library system.

### DETAILED DESCRIPTION OF THE INVENTION

Hereinafter, embodiments of the present disclosure will be described in detail with reference to the drawings. However, the detailed descriptions of known functions or components that can obscure the gist of the embodiments in the following descriptions and the accompanying drawings will be omitted. In addition, throughout the specification, when a certain portion “includes” a certain component, it means that the certain portion may further include the other component rather than precluding the other component unless specifically stated to the contrary.

The terms used in the present disclosure are only used to describe specific embodiments and are not intended to limit the present disclosure. The singular includes the plural unless the context clearly dictates otherwise. In the present application, it should be understood that the term “include” or “have” is intended to specify that a feature, a number, a step, an operation, a component, a part, or a combination thereof is present, but does not preclude the possibility of the presence or addition of one or more other features, numbers, steps, operations, components, parts, or combinations thereof in advance.

Unless especially defined otherwise, all terms used herein, including technical or scientific terms, have the same meaning as commonly understood by those skilled in the art to which the present disclosure pertains. The terms defined in a generally used dictionary should be construed as having meanings that coincide with the meanings of the terms from the context of the related technology and are not construed as an ideal or excessively formal meaning unless clearly defined in this document.

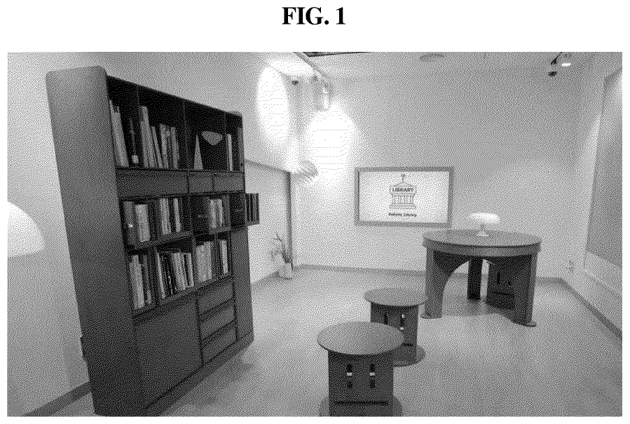

FIG. 1 is a view illustrating a library space and situation in which various embodiments of the present disclosure are implemented to adaptively establish optimal service strategies for network-connected robotic products. Referring to an exemplified space, in the corresponding space, there are at least one sensor (not illustrated) for detecting users or measuring their height, and detecting their approach and the quantity of books in a bookshelf drawer, and a plurality of homogeneous and heterogeneous robotic products, such as a bookshelf robot and a stool robot, and these robotic products collaborate by exchanging information about the user and the environment.

To this end, the present disclosure is intended to efficiently understand the intentions of library users by sharing information obtained from a plurality of homogeneous and heterogeneous robotic products connected to the same network, and to provide customized services tailored to the situational context through collaboration between the robots. In addition, as the configuration of the network-connected robotic products changes, an optimal service strategy is adaptively established, and each robotic product dedicates/transforms functions according to the situational context, in addition to original functions, to provide services desired by the users. In the exemplified library space, a bookshelf may open a drawer storing books desired by the users and provide the corresponding book to the user. In addition, the stool may have a self-movable driving unit to move according to the user's intentions or spatial context and thus may be used as a tool suitable for the situation. For example, the stool may be used as a ladder for reaching books from high shelves in a bookshelf, as a cart for transporting books, or as a stool for the user to sit on.

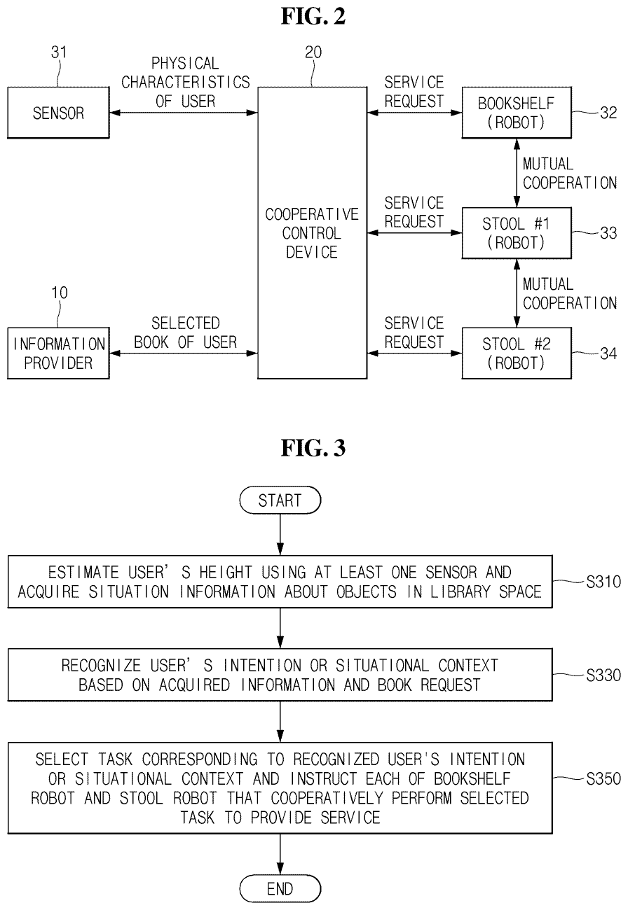

FIG. 2 is a view for describing a device configuration of the robotic products illustrated in FIG. 1 and includes an information provider 10, a sensor 31, a bookshelf 32, stools 33 and 34, and the like centered on a collaborative control device 20.

The collaborative control device 20 communicates with a plurality of robotic products 31, 32, 33, and 34 within the library and controls mutual cooperation with the robotic products. As needed, as illustrated in FIG. 2, the collaborative control device may be implemented as a separate device, or a specific robotic product may be granted master authority and set as the control entity. For example, the role of the cooperative control device 20 may be set for the bookshelf 32 of FIG. 2, and in this case, the configuration may be physically the same.

The information provider 10 may provide information about books selected by the user to the cooperative control device 20. The information provider 10 may be implemented in the form of a book application and may share selection book information of library users with other robotic products via a wireless communication method such as Bluetooth. The book information includes bibliographic information, the locations of the books within the bookshelf, and the like, thereby supporting other robotic products to perform appropriate actions. For example, the bookshelf robot may open the drawer storing the selected book in advance or use other notification methods to help the user easily take out the corresponding book.

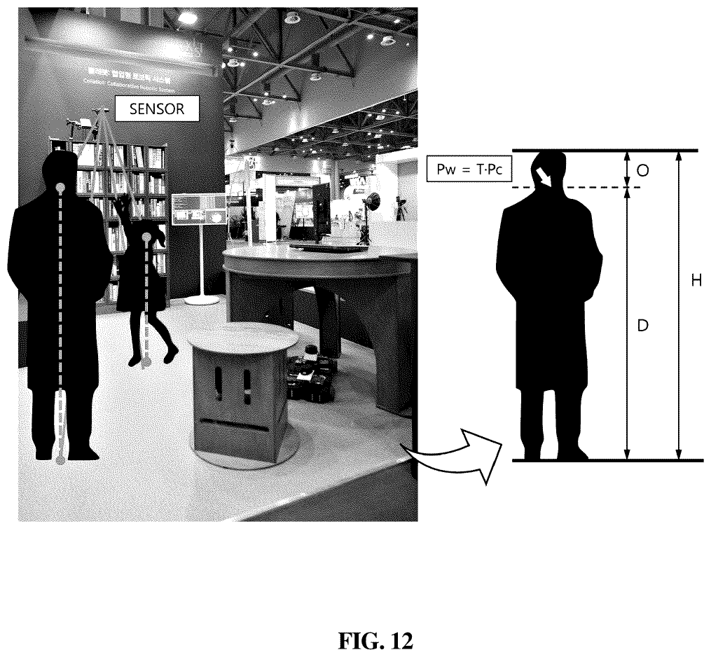

The sensor 31 may collect the physical characteristics of the user and provide the physical characteristics of the user to the cooperative control device 20. For example, a sensor for measuring height may be installed within a library space to measure the height of a user entering the space and share this data with other robotic products, thereby providing services tailored to the physical characteristics (height) of the user. When the sensor 31 is implemented as a camera having a depth sensor, there is a need for a separate algorithm for estimating the user's height from an image of the space including the user. A more specific processing process related thereto will be described in detail below with reference to FIG. 12.

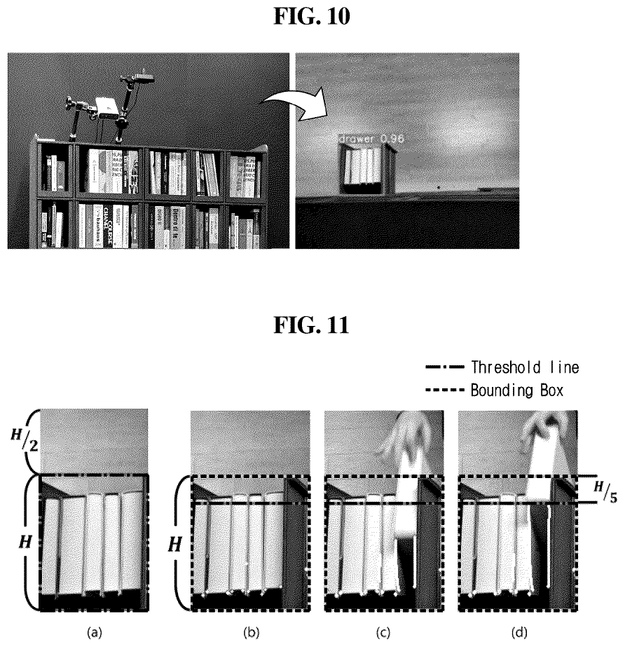

In addition, the sensor 31 detects a user approaching the bookshelf robot 32 or determines whether a book has been received from the bookshelf robot 32. When the user has normally received the book, the bookshelf robot 32 may close the bookshelf drawer based on the results detected by the sensor 31. When the sensor 31 is implemented as a camera, there is a need for a separate algorithm for detecting a book taken out from the drawer. A more specific processing process related thereto will be described in detail below with reference to FIGS. 10 and 11.

The bookshelf robot 32 may be a service robot that performs an operation of appropriately taking out stored books. For example, when a user selects a desired book (e.g., information about a requested book may be received through the information provider 10 such as an app), the drawer including the corresponding book automatically opens and closes when the user takes out the book. Based on information shared from the sensor 31 and the information provider 10, a service strategy for the user is established, and the stool robots 33 and 34 are requested to provide the service.

The stool robots 33 and 34 are service robots that have a self-movable driving unit and move to a location appropriate for the situation, and not only provides an original function of the stool, but also performs the service requested from the cooperative control device 20. To this end, the stool robots 33 and 34 alternatively serves as a ladder, a cart, or a chair.

FIG. 3 is a flowchart illustrating a method of collaboratively controlling a library system including a bookshelf robot and a stool robot according to one embodiment of the present disclosure. The library system may implement cooperative control by loading a program including commands to perform a series of processes to be described below into a memory and executing the program using at least one processor.

In operation S310, the library system estimates the user's height using at least one sensor and detects whether the user is approaching the bookshelf robot or the chair robot, thereby acquiring situational information about objects within the library space. To this end, a height measurement sensor (e.g., a camera having a depth sensor) is used to obtain a measurement value about the user and transmit the measured height information to the library system via robot operating system (ROS) communication to estimate the user's height. In addition, by tracking and monitoring the user's movement from the values measured using sensors such as cameras installed within the library space, whether the user is approaching the bookshelf robot or the chair robot may be determined, thereby providing situational information about objects within the library space.

In operation S330, the library system recognizes the user's intention or situational context based on the information acquired in operation S310 and the book request input by the user. Within a given library space, various detection information (e.g., user body information, user behavioral information, environmental information) and additional input information (e.g., book selection information) are used to identify the current intention of the user or derive situational context to infer necessary services. In this case, for a book request, information about the selected book may be input by the user through a book application, and data about the drawer storing the corresponding book may be transmitted to the bookshelf robot through the library system.

In operation S350, the library system selects a task corresponding to the user's intention or situational context recognized in operation S330 and instructs each of the bookshelf robot and the stool robot, which may collaboratively perform the selected task, to provide services. When the user's intention or situational context has been recognized, a corresponding task is required. In this case, a task does not simply represent a simple function, but may include a series of operations necessary to achieve the objectives. That is, the achievement of the task may involve a plurality of performers and a plurality of operations. When a suitable robot has been selected to achieve the task, the corresponding robot may be instructed to perform appropriate sub-functions, enabling the robots to collaborate to provide the final service. In this case, the selected robots may include not only homogeneous robotic products, but also heterogeneous robotic products, and through collaboration among heterogeneous robotic products, it is possible to achieve flexible objectives beyond unique functions of each product.

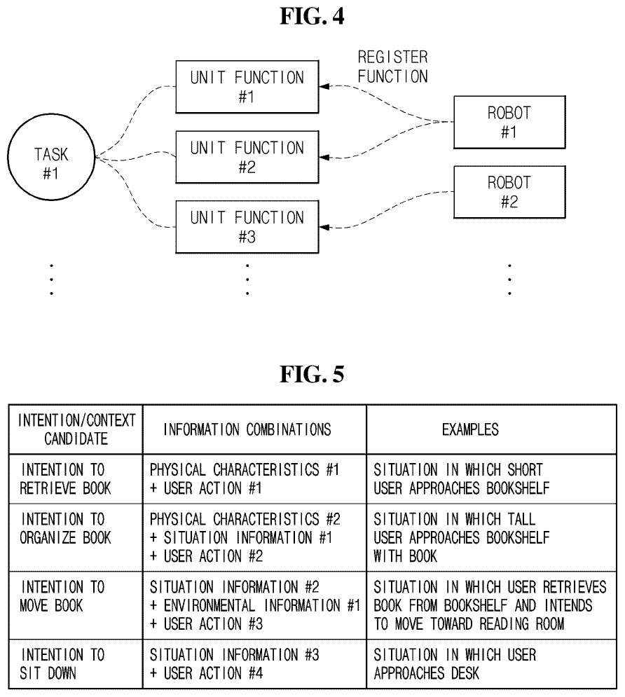

Meanwhile, it is preferable that the library system registers at least one unit function that may each be provided by the bookshelf robot and the stool robot and generates a task capable of collaboratively performing a plurality of robots from a combination of the registered unit functions prior to operation S350. FIG. 4 is a view for describing the configuration of the task proposed by various embodiments of the present disclosure and illustrates that unit functions provided by heterogeneous a plurality of robots are registered and a task may be configured by combining the registered unit functions.

Here, the unit function may be a unique function corresponding to an action that one bookshelf robot or stool robot may perform, or one of a plurality of functions that may be applied as different roles based on the user's intention or situational context for the actions that one bookshelf robot or stool robot may perform. For example, the unit function may be an “open drawer” function, which is a unique function of a bookshelf, or a “sit” function, which is a unique function of a stool. In addition, the unit function is not the unique function of the stool, but may be a “ladder” function, which helps the user reach higher locations, or a “cart” function, which allows the user to transport a plurality of books.

A task consists of a plurality of unit functions that process complex actions necessary to achieve the objectives, each unit function may be matched with a bookshelf robot or stool robot capable of providing the corresponding unit function, and the sequence of actions and communication targets among a plurality of robots cooperating to achieve the objectives may be configured. Under the collaborative control using a plurality of heterogeneous robotic products, it is not enough for each robot to simply perform its own assigned function, and each robot also needs to cooperate to perform time-series designed actions. Accordingly, through communication among robots, by sharing the processing status of currently performed unit functions, autonomously-detected situations, or environmental information, control is performed so that the task can be successfully achieved.

FIG. 5 is a view for describing the configuration of the intention or context candidates proposed by various embodiments of the present disclosure and illustrates four candidates and information combinations that constitute each candidate.

In various embodiments of the present disclosure, the process of recognizing a user's intention or situational context may include a process of receiving additional information about a book request from the user and selecting items most similar to the user's intention or situational context based on the input additional information and the detected information. For example, when information indicating a short height regarding physical characteristics is input and a user's action of approaching a bookshelf is detected, the “intention to take out a book” that is the most similar to the current intention or context may be selected from a combination thereof. As another example, when a return of a book titled “Jungle Book” is confirmed and a user approaching a bookshelf with the book is detected, the “intention to organize the book” may be selected from a combination thereof.

In addition, in various embodiments of the present disclosure, the process of selecting an item most similar among a plurality of candidates requires a process of pre-configuring a plurality of candidates for the user's intention or situational context based on a combination of at least two or more of information about the physical characteristics of the user, information about the user's surroundings, environmental information about the space in which the user is located, and information about the user's action, and the candidates configured in this way are presented as illustrated in FIG. 5. Then, using the input additional information and the detected information, the item with the highest degree of matching may be determined among the a plurality of candidates. This matching may be achieved by selecting the candidate with the highest degree of similarity in information combinations.

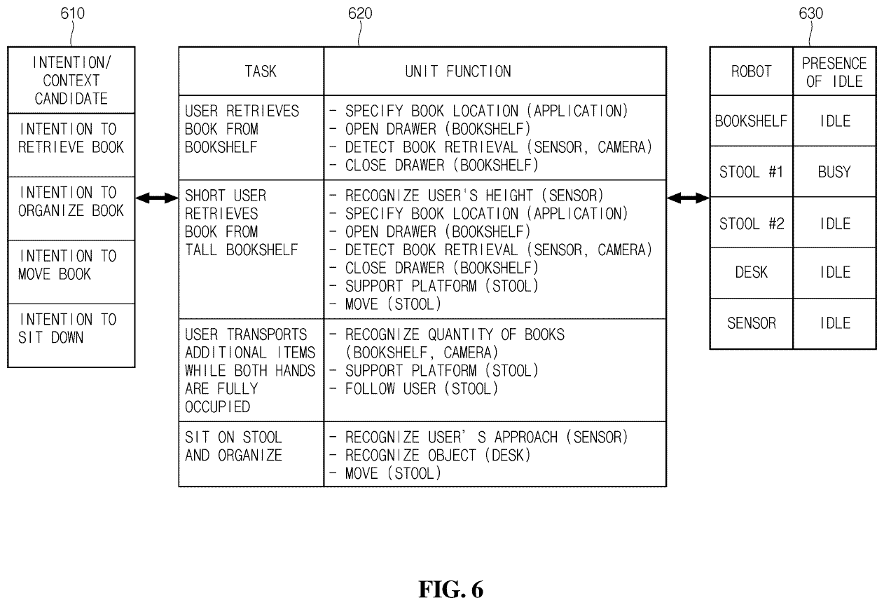

FIG. 6 is a view for describing a process of selecting a task 620 based on an intention or context 610 of FIG. 5. If necessary, a process of checking the availability of a plurality of robots may be included, and to this end, a table 630 indicating the validation of robots is referenced.

In various embodiments of the present disclosure, the process of selecting a task may select a top-priority task corresponding to the recognized user's intention or situational context and check whether the robot for collaboratively performing the top-priority task is in an idle state. Then, when the robot for collaboratively performing the top-priority task is not in an idle state, a subsequent-priority task for which a robot for collaboratively performing it is in an idle state may be selected, corresponding to the recognized user's intention or situational context. Of course, it is also possible to wait until the robot currently occupied becomes idle.

Here, each item of the intention/context candidate 610 and the task 620 may be matched in a many-to-many relationship, and the matching relationship needs to be set in advance. For example, at least one task corresponding to the “intention to move a book” may be present, and FIG. 6 may include tasks “a user takes out a book from a bookshelf” and “a short user takes out a book from a tall bookshelf.” In addition, when the intention/context candidate 610 and the task 620 are multiply matched, a priority may be assigned according to a predetermined rule. The priority may be assigned a relatively high/low ranking based on the degree of matching between the required unit functions, and a relative ranking may be assigned based on the idleness of individual robots related to the task.

The unit functions of each task 620 illustrated in FIG. 6 will be described in more detail as follows.

First, for the task corresponding to “A user takes out a book from a bookshelf,” the book request of the user is received through the application, and the unit function for specifying a “location” of the bookshelf storing the book is required. Accordingly, the bookshelf may need to “open” a specific drawer and “sense” the user's action of taking out the corresponding book, and may execute a unit function for “closing” the drawer when the book is successfully taken out.

Second, for the task corresponding to “A short user takes out a book from a tall bookshelf,” a unit function for “recognizing” the user's height and a unit function in which the stool communicates with the bookshelf and “moves” to the location of the book are additionally required.

Third, for the task corresponding to “Carry additional items while holding both hands full,” the bookshelf or camera requires a unit function for “recognizing” the quantity of books the user has taken out, and this allows the bookshelf to recognize which items the user has taken out from a storage and determine whether the user may freely use his or her hands. In addition, the stool requires a unit function for approaching and “following” the user when a predetermined number or size of items are taken out from the storage.

Fourth, for the task corresponding to “Sit on the stool and organize,” a unit function for “moving” is required to perform the primary function of the stool. For example, when a user attempts to sit down, a movement function is required to slightly step back from the desk, when the user briefly leaves the desk, a function for recognizing objects on the desk and maintaining their state is required, and when the user completely leaves the desk (when there are no objects on the desk and the user is also away), a function for re-storing a stool under the desk and organizing the area is required.

Accordingly, in various embodiments of the present disclosure, a process of commanding each of the bookshelf robot and the stool robot to provide a service may include a process of selecting a task corresponding to the recognized user's intention or situational context, identifying a plurality of unit functions matching the selected task, and instructing each of the bookshelf robot and the stool robot capable of performing the identified unit functions to perform the corresponding unit functions in a time-series manner. Furthermore, the process of requesting service provision may achieve more sophisticated interaction and action performance by controlling the exchange of information about the performance order and process between robots.

In addition, the process of instructing each of the bookshelf robot and the stool robot to perform the corresponding unit functions in a time-series manner may include a process of activating a drawer opening function by instructing the bookshelf robot to protrude a requested book or a drawer storing the requested book. Conversely, the process may also include a process of deactivating the drawer opening function of the bookshelf robot by detecting the user's book retrieval using at least one sensor. For controlling the drawer, it is possible to determine whether the user has retrieved the corresponding book by estimating the movement of the book through recognizing the protruded requested book or drawer using the at least one sensor corresponding to the activated drawer opening function. When it is determined that the user has retrieved the book, the drawer opening function may be deactivated by returning the protruded drawer to its original location.

Meanwhile, the process of instructing each of the bookshelf robot and the stool robot to perform the corresponding unit functions in a time-series manner may further include a process of selectively moving the stool robot and activating a ladder function for supporting the user, based on a difference between an estimated height of the user and a book storage location of the bookshelf robot approached by the user. In addition, the process may further include a process of selectively moving the stool robot and activating a support platform function for carrying books, based on the quantity of books detected using at least one sensor.

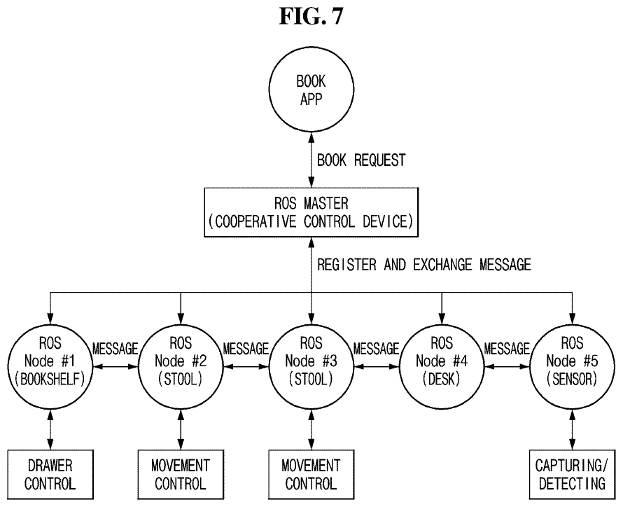

FIG. 7 is a view for describing a connection structure among devices in a library system for implementing various embodiments of the present disclosure and illustrates a robot operating system (ROS) that provides, as an implementation means, hardware abstraction, lower-level device control, implementation of commonly used functions, inter-process message passing, package management, libraries required for a development environment, and various development and debugging tools when developing robotic applications. Such an ROS serves as a robotic platform, such as an operating system for developing a robotic application program, includes a hardware platform with hardware abstraction, and serves as a software platform for supporting robotic application program development while having an operating system-like function usable across heterogeneous hardware.

Referring to FIG. 7, the cooperative control device is set as a ROS master and may identify available robotic resources and functions provided by registering various ROS nodes. The ROS nodes may include not only various robotic products such as a bookshelf robot, a stool robot, a desk robot, and the like exemplified above, but also various sensors, and the ROS nodes may recognize one another's states and requirements by exchanging messages through intercommunication. In addition, a book request selected by a user may be received through a library application. For example, based on a book request and detection results obtained through a sensor or camera, a storage location of the corresponding book may be specified for the bookshelf robot, and the bookshelf robot may control a drawer to protrude, thereby guiding the user to retrieve the book. When it is detected through the sensor that the user has retrieved the book, the bookshelf robot may control the drawer to close the protruded drawer. Likewise, when the quantity of books to be carried by the user is large or when the user is shorter in height relative to the bookshelf, the stool robot may be controlled to move, thereby serving as a cart for transporting the books or as a ladder for supporting the user.

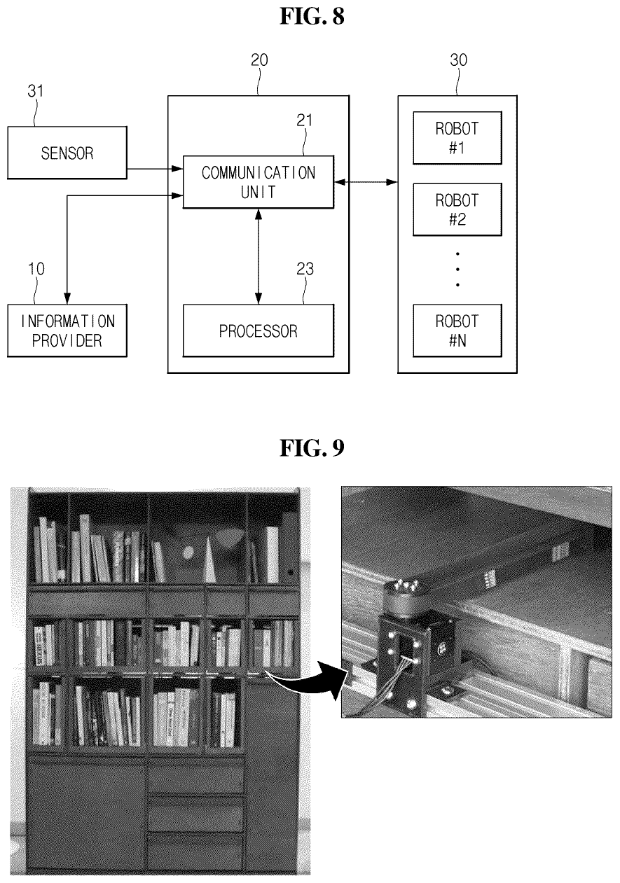

FIG. 8 is a block diagram illustrating a library system 20 for cooperatively controlling a bookshelf robot and a stool robot 30 according to an embodiment of the present disclosure, in which the cooperative control method of FIG. 3 described in terms of a sequential process flow is reorganized in terms of a hardware configuration. Accordingly, to avoid the overlapping description, only functions and operations of each component will be briefly described herein.

The library system 20 includes a communication unit 21 for receiving measurement values detected by at least one sensor 31, and a processor 23 for executing commands to control the bookshelf robot and the stool robot 30 to provide services required by a user. More specifically, the processor 23 may estimate a user's height based on the input measurement values, detect whether the user approaches the bookshelf robot or the stool robot to acquire situational information about objects in the library space, recognize the user's intention or situational context based on the acquired information and a book request input by the user, select a task corresponding to the recognized intention or situational context, and instruct each of the bookshelf robot and the stool robot capable of cooperatively performing the selected task to provide the service.

The processor 23 may register at least one unit function available from each of the bookshelf robot and the stool robot 30 and pre-generate cooperative tasks that may be performed by a plurality of robots from a combination of the registered unit functions.

The processor 23 may receive additional information about the book request from the user (or from an information provider 10 such as an application) and recognize the user's intention or situational context by selecting an item that is most similar among candidates for the user's intention or situational context based on the input additional information and detected information.

The processor 23 may select a task corresponding to the recognized user's intention or situational context, identify a plurality of unit functions matched to the selected task, and instruct each of the bookshelf robot and the stool robot 30 capable of performing the identified unit functions to perform the unit functions in a time-series manner.

In addition, the processor 23 may activate a drawer opening function by instructing the bookshelf robot 30 to protrude a requested book or a drawer storing the requested book, recognize the protruded requested book or drawer using the at least one sensor corresponding to the activated drawer opening function to estimate movement of the book, and when it is determined that the user has retrieved the book, return the protruded drawer to its original location to deactivate the drawer opening function of the bookshelf robot.

Furthermore, the processor 23 may selectively move the stool robot and activate a ladder function for supporting the user based on a difference between the estimated height of the user and the book storage location of the bookshelf robot approached by the user, and may also selectively move the stool robot and activate a support platform function for transporting the books based on the quantity of books detected using at least one sensor.

FIGS. 9 to 11 are views for describing the operation of a drawer opening function using a prototype of a bookshelf robot for the library system.

Referring to FIG. 9, when the bookshelf robot receives book information selected by the user from a library application based on wireless communication such as Bluetooth, the bookshelf robot may protrude a drawer storing the selected book or the corresponding book using a built-in driving unit (motor and belt). Then, when the user takes out the book, the book being taken out is recognized, and the drawer is automatically closed. During this process, the bookshelf robot may control opening/closing of the drawer by detecting, through a separate sensor (e.g., a camera), whether the user has properly taken out the corresponding book. In addition, the bookshelf robot may integrate the user's physical information (height), the book information selected by the user, and the drawer opening/closing information and provide the integrated information to a chair through ROS communication, thereby issuing a command to guide the chair to move.

Referring to FIGS. 10 and 11, a process of estimating movement of a book within a bookshelf drawer using a camera installed on an upper end of the bookshelf robot is illustrated. First, when the user requests a desired book, a bookshelf compartment storing the requested book protrudes. Then, from an image captured by the camera installed on the upper end, the protruded bookshelf drawer may be recognized using an object detection model (e.g., YOLOv5). Subsequently, the movement of the book within the detected bookshelf drawer may be estimated. For estimating the movement of the book, an optical flow algorithm may be used, and when a generated movement path of the book crosses a predetermined threshold line, it is determined that the user has taken out the book, and the protruded drawer may be returned to its original location.

Here, the optical flow algorithm is a technique for estimating movements of objects in an image and analyzes pixel motion between two consecutive frames to calculate speed and direction information. This algorithm is widely applied in the computer vision field, such as for object tracking, motion analysis, and 3D structure reconstruction, and several detailed algorithms may be selected. For example, a Lucas-Kanade method estimates motion within a small window (local region) and calculates motion vectors using linear equations. A Horn-Schunck method calculates motion across the entire frame and performs global energy minimization to ensure smoothness of motion vectors. A Farneback method uses polynomial approximation to analyze pixel motion and calculates dense optical flow.

Referring to FIG. 11, FIG. 11A illustrates an image of a region of interest (ROI) of the detected bookshelf drawer, in which a height of the ROI may be set as the sum of the detected drawer height H and H/2. Referring to FIGS. 11B, 11C, and 11D illustrating sequential images of the user retrieval of the book, the location of the threshold line is set at a point H/5 below an upper end of the detected bookshelf drawer. FIG. 11 illustrates results of estimating the movement of the book using the Lucas-Kanade optical flow algorithm on the ROI image obtained through bookshelf drawer recognition. When the movement path generated through the optical flow crosses a threshold line d, it is determined that the user has retrieved the book, and the protruded drawer is returned to its original location.

In summary, the process of instructing the bookshelf robot to perform the corresponding unit function in a time-series manner may include a process of recognizing the protruded requested book or drawer corresponding to the activated drawer opening function using at least one sensor, setting the recognized book or drawer as an ROI, estimating the movement of a book within the ROI using an optical flow algorithm, and determining whether the estimated movement of the book crosses a threshold line set adjacent to the ROI. When the movement of the book crosses the threshold line, it is determined that the user has retrieved the book, and the protruded drawer may be returned to its original location, thereby deactivating the drawer opening function.

FIG. 12 is a view for describing a process of estimating a user's height through a sensor prototype of the library system, assuming that a sensor is installed on the upper end of the bookshelf robot or in an upper space of the library. Such a sensor provides measurement values for estimating the height of a user located in the space, and an RGB-D camera capable of acquiring images including depth information may be used. In terms of implementation, for example, Microsoft's Azure Kinect camera and Azure Kinect Body Tracking SDK may be used to estimate human joints. An estimated location of a head joint obtainable at this time approximates the center of the head, and by calculating a Euclidean distance from the floor plane, the height of the user may be estimated by calculating the Euclidean distance from the floor plane and correcting the height up to the top of the head.

More specifically, by receiving a depth image from the camera and performing skeleton tracking, coordinates Pc in the camera coordinate system are obtained for each human joint. Then, for camera calibration, a Euclidean transformation matrix T of the camera is calculated such that the floor plane of the depth camera corresponds to Z=0 in the world coordinate system.

$$T = [ \begin{matrix}{R}_{3 \times 3} & {R}_{3 \times 1} \\ 0 & 1\end{matrix} ] \qquad [ Equation 1 ]$$

where R_{3×3} is a rotation matrix representing an attitude (orientation) of a camera, and T_{3×1} is a translation vector defining the location of the camera.

The coordinates Pc in the camera coordinate system are converted into coordinates Pw in the world coordinate system in which the floor plane corresponds to z=0.

$$Pw = T \cdot Pc \qquad [ Equation 2 ]$$

where z of Pw indicates a vertical height because the world coordinate floor plane is z=0.

By adding a predetermined offset O (e.g., 15 cm) from the head joint to the top of the head to a Z-axis component D (vertical height) of the head joint Pw, a height H may be estimated.

$$H = D + O \qquad [ Equation 3 ]$$

Through this height estimation process, when it is determined that the height of the target bookshelf is greater than the user's height, the stool robot moves to serve as a ladder for supporting the user.

In summary, the process of instructing the bookshelf robot to perform the corresponding unit function in a time-series manner may include a process of acquiring coordinates of the head joint of the user in the camera coordinate system based on depth information measured by at least one sensor, calculates a Euclidean distance, with respect to a floor plane of a space in which the user is located, from the coordinate value in the camera coordinate system using conversion between the camera coordinate system and the world coordinate system, estimating the user's height by adding an offset corresponding to the head region to the calculated Euclidean distance, and activating a ladder function by selectively moving the stool robot based on a difference between the estimated height of the user and a book storage location of the bookshelf robot approached by the user.

Meanwhile, the process of instructing each of the bookshelf robot and the stool robot to perform the corresponding unit functions in a time-series manner may further include a process of selectively moving the stool robot and activating a support platform function for transporting books based on the quantity of books detected using at least one sensor.

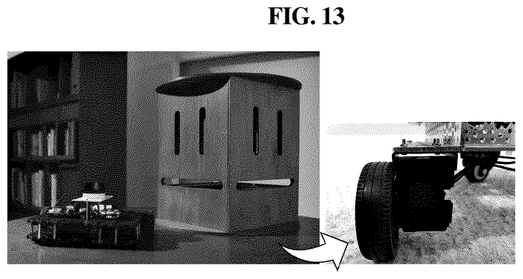

FIG. 13 is a view illustrating a prototype of a stool robot for the library system. Referring to FIG. 13, the stool robot includes a communication unit for receiving movement commands from the library system, a driving unit such as wheels for self-movement, and may optionally include a sensor for recognizing approach of objects. When the user approaches a desk, the stool robot serves as a “chair” and slightly moves rearward to facilitate the user sitting down. Depending on the situation, the stool robot serves as a “cart” by moving next to the bookshelf robot so that the user may use the stool robot for transporting books. In addition, depending on the situation, the stool robot serves as a “ladder” by moving in front of the bookshelf robot in which the desired book is located so that the user may step on the stool to retrieve the book.

Various embodiments of the present disclosure may be implemented by various means, such as hardware, firmware, software, or a combination thereof. When implemented by hardware, one embodiment of the present disclosure may be implemented by one or more application specific integrated circuits (ASICs), digital signal processors (DSPs), digital signal processing devices (DSPDs), programmable logic devices (PLDs), field programmable gate arrays, controllers, microcontrollers, microprocessors, etc. In the case of implementation through firmware or software, an embodiment of the present disclosure may be implemented in the form of modules, procedures, functions, or the like configured to perform the capabilities or operations described above. The software code may be stored in a memory and executed by a processor. The memory may be located inside or outside the processor and may exchange data with the processor through various known means.

Meanwhile, various embodiments of the present disclosure may be implemented with computer-readable code on a computer-readable recording medium. The computer-readable recording media include all types of recording devices that store data readable by a computer system. Examples of the computer-readable recording media include a ROM, a RAM, a CD-ROM, a magnetic tape, a floppy disk, optical data storage devices, etc. In addition, the computer-readable recording media may be distributed across a network-connected computer system to allow the computer-readable code to be stored and executed in a distributed manner. In addition, functional programs, codes, and code segments for implementing the present disclosure can be easily inferred by programmers in the art to which the present disclosure pertains.

According to various embodiments of the present disclosure, by sharing user information and environmental information acquired from a plurality of homogeneous and heterogeneous robotic products and sensors installed in a library through communication between robots, the intentions of library users can be more specifically identified and the situational context can be recognized more efficiently, and by integrating the functions of each robot through collaboration between the robots, optimal user services for library users and a rich user experience beyond the unique functions of the robots can be provided.

The present disclosure has been described above with reference to various embodiments thereof. Those skilled in the art to which the present disclosure pertains will be able to understand that various embodiments may be implemented in a modified form without departing from the essential characteristics of the present disclosure. Accordingly, the disclosed embodiments should be considered in an illustrative rather than a limiting sense. The scope of the present disclosure is described in the claims rather than the above description, and all differences in the equivalent scope should be construed as being included in the present disclosure.

### DESCRIPTION OF REFERENCE NUMERALS

10: information provider
20: library system (or cooperative control device)
21: communication unit
23: processor
30, 32, 33, 34: robot
31: sensor

What is claimed is:

1. A method for collaborative control of a library system including a bookshelf robot and a stool robot, the method comprising:
estimating, by the library system, a user's height using at least one sensor and detecting whether the user is approaching the bookshelf robot or the stool robot to obtain situational information about objects within a library space;
recognizing, by the library system, the user's intention or situational context based on the acquired information and a book request input by the user; and
selecting, by the library system, a task corresponding to the recognized user's intention or situational context and instructing each of the bookshelf robot and the stool robot, which collaboratively perform the selected task, to provide services.

2. The method of claim 1, further comprising registering at least one unit function provided by each of the bookshelf robot and the stool robot and generating in advance performable tasks for collaborative operation by a plurality of robots from a combination of the registered unit functions.

3. The method of claim 2, wherein the unit function is a unique function corresponding to an action performable by one bookshelf robot or stool robot and any one of a plurality of functions applicable as different roles depending on the user's intention and situational context with respect to the performable action of the one bookshelf robot or stool robot, and
the task consists of a plurality of unit functions that process complex actions necessary to achieve objectives, each unit function is matched with the bookshelf robot or stool robot that provides the corresponding unit function, and a sequence of actions and communication targets among a plurality of robots cooperating to achieve the objectives is configured.

4. The method of claim 1, wherein the recognizing of the user's intention or the situational context includes:
receiving additional information about a book request from the user; and
selecting an item that is most similar among candidates for the user's intention or situational context based on the input additional information and the detected information.

5. The method of claim 1, wherein the instructing of each of the bookshelf robot and the stool robot to provide a service includes:
selecting a task corresponding to the recognized user's intention or situational context;
identifying a plurality of unit functions matching the selected task; and
instructing each of the bookshelf robot and the stool robot that perform the identified unit functions to perform the corresponding unit functions in a time-series manner.

6. The method of claim 5, wherein the instructing of each of the bookshelf robot and the stool robot to perform the corresponding unit functions in a time-series manner includes:
activating a drawer opening function by instructing the bookshelf robot to protrude a requested book or a drawer storing the requested book; and
deactivating the drawer opening function of the bookshelf robot by detecting the user's book retrieval using the at least one sensor.

7. The method of claim 6, wherein the instructing of each of the bookshelf robot and the stool robot to perform the corresponding unit functions in a time-series manner further includes recognizing the protruded requested book or drawer corresponding to the activated drawer opening function using the at least one sensor, setting the recognized book or drawer as a region of interest (ROI), estimating movement of a book within the set ROI using an optical flow algorithm, and determining whether the estimated movement of the book crosses a threshold line set adjacent to the ROI, and
the deactivating of the drawer opening function includes, when the movement of the book crosses the threshold line, determining that the user has received the book and returning the protruded drawer to its original location.

8. The method of claim 5, wherein the instructing of each of the bookshelf robot and the stool robot to perform the corresponding unit functions in a time-series manner includes:
selectively moving the stool robot to activate a ladder function for supporting the user based on a difference between the estimated height of the user and a book storage location of the bookshelf robot the user is approaching; or
selectively moving the stool robot and activating a support platform function for carrying books, based on an quantity of books detected using the at least one sensor.

9. The method of claim 8, wherein the activating of the ladder function for supporting the user includes acquiring coordinate values of a camera coordinate system for a head joint of the user based on depth information measured using the at least one sensor, calculating a Euclidean distance, with respect to a floor plane of a space in which the user is located, from the coordinate values in the camera coordinate system using a transformation between the camera coordinate system and a world coordinate system, and estimating the user's height by adding an offset corresponding to a head region to the calculated Euclidean distance.

10. A library system for cooperatively controlling a bookshelf robot and a stool robot, comprising:
a communication unit configured to receive measurement values detected using at least one sensor, and
a processor configured to execute commands to control the bookshelf robot and the stool robot to provide a service required by a user,
wherein the processor is configured to estimate a user's height based on the input measurement values, detect whether the user approaches the bookshelf robot or the stool robot to acquire situational information about objects in a library space, recognize the user's intention or situational context based on the acquired information and a book request input by the user, select a task corresponding to the recognized intention or situational context, and instruct each of the bookshelf robot and the stool robot that cooperatively perform the selected task to provide a service.

11. The library system of claim 10, wherein the processor is configured to register at least one unit function provided by each of the bookshelf robot and the stool robot and generate in advance performable tasks for collaborative operation by a plurality of robots from a combination of the registered unit functions.

12. The library system of claim 10, wherein the processor is configured to receive additional information about the book request from the user and recognize the user's intention or situational context by selecting an item that is most similar among candidates for the user's intention or situational context based on the input additional information and detected information.

13. The library system of claim 10, wherein the processor is configured to select a task corresponding to the recognized user's intention or situational context, identify a plurality of unit functions matched to the selected task, and instruct each of the bookshelf robot and the stool robot that perform the identified unit functions to perform a corresponding unit function in a time-series manner.

14. The library system of claim 13, wherein the processor is configured to:
activate a drawer opening function by instructing the bookshelf robot to protrude a requested book or a drawer storing the requested book;
recognize the protruded requested book or drawer corresponding to the activated drawer opening function using the at least one sensor, set the recognized book or drawer as a region of interest (ROI), estimate movement of a book within the set ROI using an optical flow algorithm, and determine whether the estimated movement of the book crosses a threshold line set adjacent to the ROI; and
when the movement of the book crosses the threshold line, determine that the user has retrieved the book and return the protruded drawer to its original position to deactivate the drawer opening function.

15. The library system of claim 13, wherein the processor is configured to:
acquire coordinate values of a head joint of the user in a camera coordinate system based on depth information measured by the at least one sensor, calculate a Euclidean distance from the coordinate values in the camera coordinate system to a floor plane of a space in which the user is located using conversion between the camera coordinate system and a world coordinate system, estimate the user's height by adding an offset corresponding to a head region to the calculated Euclidean distance, and activate a ladder function by selectively moving the stool robot based on a difference between the estimated height of the user and a book storage position of the bookshelf robot approached by the user; or
selectively move the stool robot and activate a support platform function for carrying books, based on an quantity of books detected using the at least one sensor.
